(19) United States
(12) Patent Application Publication
(10) Pub. No.: US 2012/0004945 A1
(43) Pub. Date: Jan. 5, 2012

(54) GOVERNANCE, RISK, AND COMPLIANCE SYSTEM AND METHOD

(75) Inventor: Kishor Vaswani, McLean, VA (US)

(73) Assignee: OSP Global LLC D/B/A Control Case, McLean, VA (US)

(21) Appl. No.: 13/169,461

(22) Filed: Jun. 27, 2011

Related U.S. Application Data
(60) Provisional application No. 61/361,074, filed on Jul. 2, 2010.

(51) Int. Cl. G06Q 10/00

(52) U.S. Cl. 705/7.28

(57) ABSTRACT

An automated system and method is provided for conducting governance, risk management, and/or regulatory compliance audits within an organization. In embodiments, a regulatory compliance unit probes one or more computing devices on an organization's network in an attempt to identify non-compliant assets, including security vulnerabilities, unprotected or improperly-stored data, misconfiguration, outdated software, malware, missing or corrupted data, and the like. The disclosed system includes the capability to collect information from non-digital assets in an organization, including automatically conducting surveys among one or more persons within an organization to confirm such person's knowledge is in compliance with applicable requirements. The disclosed system also includes the ability to automatically discover target devices for further analysis. The regulatory compliance unit includes a data collection unit, a compliance scanning unit, a reporting unit, and a user console unit.

### CROSS REFERENCE TO RELATED APPLICATION

This application claims the benefit of and priority to U.S. Provisional Application Ser. No. 61/361,074 entitled “GOVERNANCE, RISK, AND COMPLIANCE SYSTEM AND METHOD” filed Jul. 2, 2010 by Kishor Vaswani, the entirety of which is hereby incorporated by reference herein for all purposes.

### BACKGROUND

1. Technical Field

The present disclosure relates to the governance, risk management, and regulatory compliance aspects of an organization, and in particular, computerized systems and methods for collecting, analyzing, and reporting governance, risk, and compliance information relating to an organization.

2. Background of Related Art

In today's increasingly complex business and regulatory environment, is it incumbent upon businesses and other organizations to monitor and control all aspects of the enterprise in order to assure established business practices and policies are followed, to reduce exposure to liability and loss, and to ensure compliance with myriad government regulations. An organization's approach to achieving this triad of related objectives is known as governance, risk management, and regulatory compliance, or “GRC.”

Generally, governance refers to the overall strategy by which management directs and controls the entire organization. Risk management is the process by which an organization seeks to identify, respond to, and avoid risks that may adversely impact the organization. Often-considered risks include technological risks, commercial risks, financial risks, safety risks, health risks, and security risks. Compliance refers to assuring that an organization operates in conformance with government regulations and laws. An organization may be subject to multiple or overlapping sets of regulations depending upon the jurisdictions in which it operates. It is not uncommon for the realms of governance, risk management, and regulatory compliance to overlap.

In many aspects, implementing a GRC plan is an inherently manual process whereby specialists, who are often hired consultants, collect data from within the enterprise by various means. Commonly, the specialists analyze the collected data in accordance with their customary methodologies, and present findings to management in a variety of formats. Management, in turn, may take corrective or enforcement action based upon the findings. This approach to GRC may have drawbacks, since manual processes tend to be costly and error-prone. The subjective biases inherent in manual processes are naturally subject to the priorities of the individual specialist(s) involved, particularly with respect to the data collection and analysis tasks. Additionally, manual GRC tends to be time consuming and often involves multiple meetings attended by specialists, management, and staff. A system and method which performs GRC with increased efficiency, effectiveness, and objectivity would be a welcome advance.

### SUMMARY

The present disclosure is directed to a computerized system, apparatus, and method for performing automated governance, risk management, and/or compliance scanning. In one embodiment, the disclosed system includes a regulatory compliance scanning unit. The regulatory compliance scanning unit includes at least one processor and a data collection unit operably coupled to the processor. The data collection unit includes a target identification unit configured to identify a target for compliance scanning, and a data identification unit configured to identify a candidate technical data item in a target and receive the identified technical data item. The data identification unit may be configured to transmit authentication information to a target. The regulatory compliance scanning unit further includes a compliance scanning unit operably coupled to the processor. The compliance scanning unit includes a signature repository storing one or more compliance signatures defining one or more regulatory compliance rules, a parsing engine configured to identify regulatory data within identified technical data, and a regulatory mapping unit configured to evaluate regulatory data in view of one or more regulatory compliance rules. The regulatory compliance scanning unit further includes a reporting unit operably coupled to the processor that is configured to present regulatory compliance scan results to a user; and a user console unit operably coupled to the processor that is configured to facilitate user interaction with the regulatory compliance scanning unit.

The data collection unit may include an extrinsic data collection unit that is configured to receive technical and/or extrinsic data from an extrinsic data interface unit. The extrinsic data interface unit may be configured to receive technical data information from a user. The extrinsic data interface unit may be configured to receive technical data information via at least one of a user input or a machine-readable optical code. In some embodiments, the extrinsic data interface unit may include one or more extrinsic query templates. An extrinsic query template may define a questionnaire adapted to solicit human input. A user console unit in accordance with the present disclosure may enable a user to configure a parameter related to at least one of the data collection unit, the compliance scanning unit, the reporting unit, a target device, or an extrinsic target. In some embodiments, the data collection unit may include a target discovery unit configured to detect one or more targets not previously identified.

In another aspect, the present disclosure is directed to a computer-implemented method for performing organizational governance, risk, and compliance management. The disclosed method includes specifying a target for scanning, establishing a communication link with the specified target, identifying technical data within the specified target, receiving the identified technical data, parsing the technical data into one or more lexical units, selecting a regulatory map against which the one or more lexical units are evaluated, determining whether the one or more lexical units is in compliance with the selected regulatory map, and providing the results of the determining step to a user. The results of the determining step are provided to a user by a web browser. The specifying step may include specifying an IP address of the target device. The method may include the steps of determining whether extrinsic data is to be collected, establishing a communication link with an extrinsic data collection unit, collecting extrinsic data from an extrinsic data target at the extrinsic data collection unit, and receiving the collected extrinsic data. The extrinsic data target may be contacted by an email message, an SMS message, or by a telephone call. A remediation suggestion may be offered to a user in response to a determination that the one or more lexical units is not in compliance with the selected regulatory map. The disclosed method may include the step of receiving payment information from a user.

The present disclosure is also directed to non-transitory machine-readable media storing a set of instructions executable on a processor for performing a method for performing organizational governance, risk, and compliance management as described herein.

### BRIEF DESCRIPTION OF THE DRAWINGS

Various embodiments of the disclosed system and method are described herein with reference to the drawings wherein:

FIG. 1 is a block diagram of an embodiment of a governance, risk, and compliance system in accordance with the present disclosure;

FIG. 2 is a block diagram of an embodiment of a data collection unit in accordance with the present disclosure;

FIG. 3 is a block diagram of an embodiment of a compliance scanning unit in accordance with the present disclosure;

FIGS. 4A and 4B are flowcharts of an embodiment of a method of performing a regulatory scan in accordance with the present disclosure;

FIG. 5 is an example embodiment of a results report in accordance with the present disclosure;

FIG. 6 is an example embodiment of an automated governance, risk, and compliance scan user interface in accordance with the present disclosure;

FIG. 7 is an example embodiment of a requirements view in accordance with the present disclosure;

FIG. 8 is an example embodiment of an organizational asset view in accordance with the present disclosure; and

FIG. 9 is an example embodiment of an extrinsic data collection user interface in accordance with the present disclosure.

### DETAILED DESCRIPTION

The present disclosure is directed to a computer-implemented governance, risk, and compliance system. Particular embodiments of the present disclosure are described hereinbelow with reference to the accompanying drawings; however, it is to be understood that the disclosed embodiments are merely examples of the disclosure, which may be embodied in various forms and architectures. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the teachings of the present disclosure in virtually any appropriately detailed structure. In the discussion contained herein, the terms “user interface element” and/or “button” are understood to be non-limiting, and include other user interface elements such as, without limitation, a hyperlink, clickable image, and the like.

Additionally, embodiments the present disclosure may be described herein in terms of functional block components, optional selections, page displays, and various processing steps. It should be appreciated that such functional blocks may be realized by any number of hardware and/or software components configured to perform the specified functions. For example, embodiments of the present disclosure may employ various integrated circuit components, e.g., memory elements, processing elements, logic elements, look-up tables, and the like, which may carry out a variety of functions under the control of one or more microprocessors or other control devices. The present disclosure may be embodied in whole or in part in a network appliance.

Similarly, the software elements of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed at least in part by any computer having an internet web browser, on a variety of operating systems including Windows™, Macintosh™, and/or Linux. Further, it should be noted that embodiments of the present disclosure may employ any number of conventional techniques for data transmission, signaling, data processing, network control, and the like.

It should be appreciated that the particular implementations shown and described herein are illustrative of the disclosure and its best mode and are not intended to otherwise limit the scope of the present disclosure in any way. Examples are presented herein which may include sample data items (e.g., names, dates, etc.) which are intended as examples and are not to be construed as limiting. Indeed, for the sake of brevity, conventional data networking, application development and other functional aspects of the systems (and components of the individual operating components of the systems) may not be described in detail herein. Furthermore, the connecting lines shown in the various figures contained herein are intended to represent example functional relationships and/or physical or virtual couplings between the various elements. It should be noted that many alternative or additional functional relationships or physical or virtual connections may be present in a practical electronic data communications system.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like, and may be transitory or non-transitory in nature.

The present disclosure is described below with reference to block diagrams and flowchart illustrations of methods, apparatus (e.g., systems), and computer program products according to various aspects of the disclosure. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components in accordance with the present disclosure may include any combination of databases or components at a single location or at multiple locations, wherein each database or system includes any of various suitable security features, such as firewalls, access codes, encryption, de-encryption, compression, decompression, and/or the like.

The scope of the disclosure should be determined by the appended claims and their legal equivalents, rather than by the examples given herein. For example, the steps recited in any method claims may be executed in any order and are not limited to the order presented in the claims. Moreover, no element is essential to the practice of the disclosure unless specifically described herein as “critical” or “essential.”

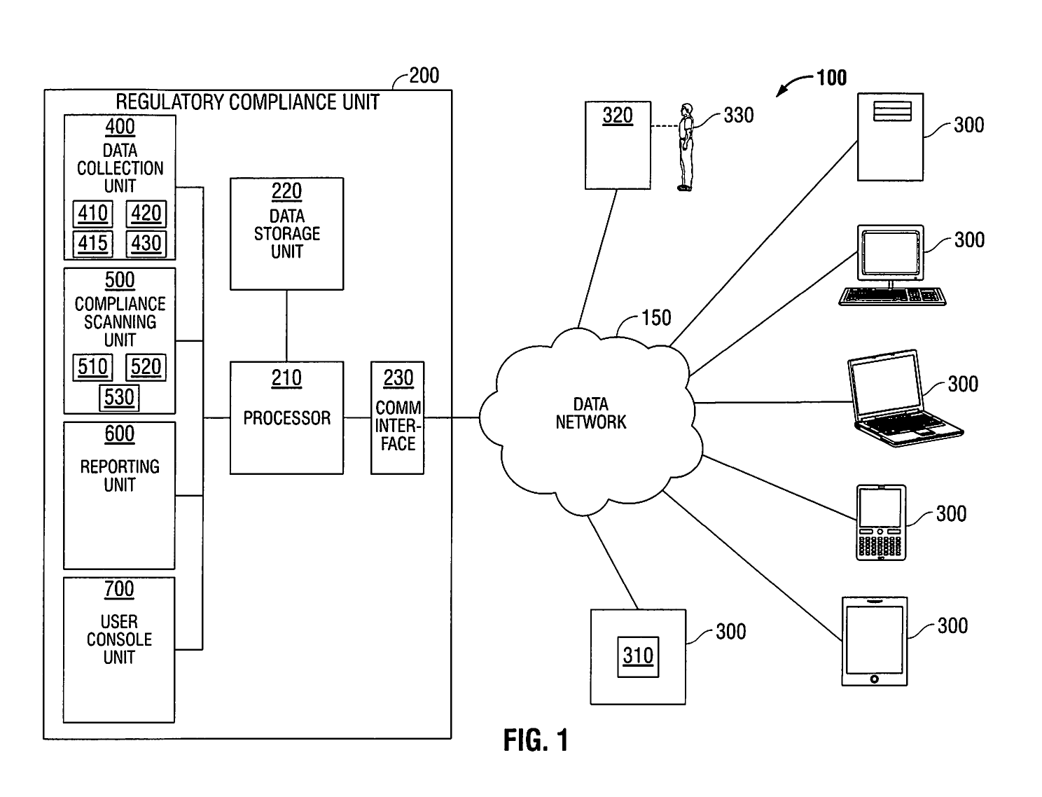

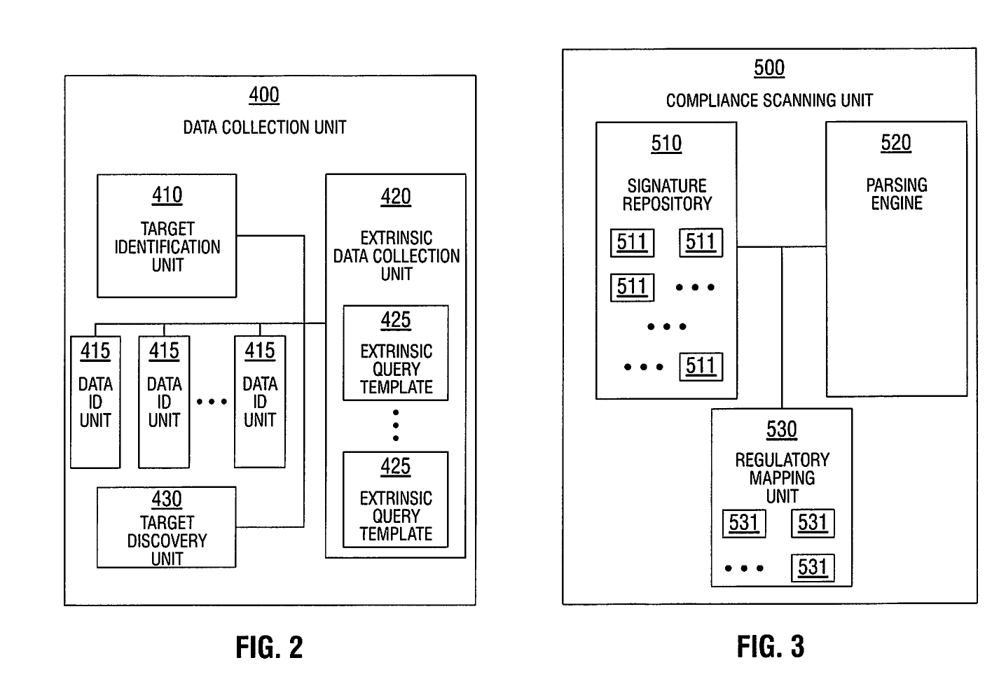

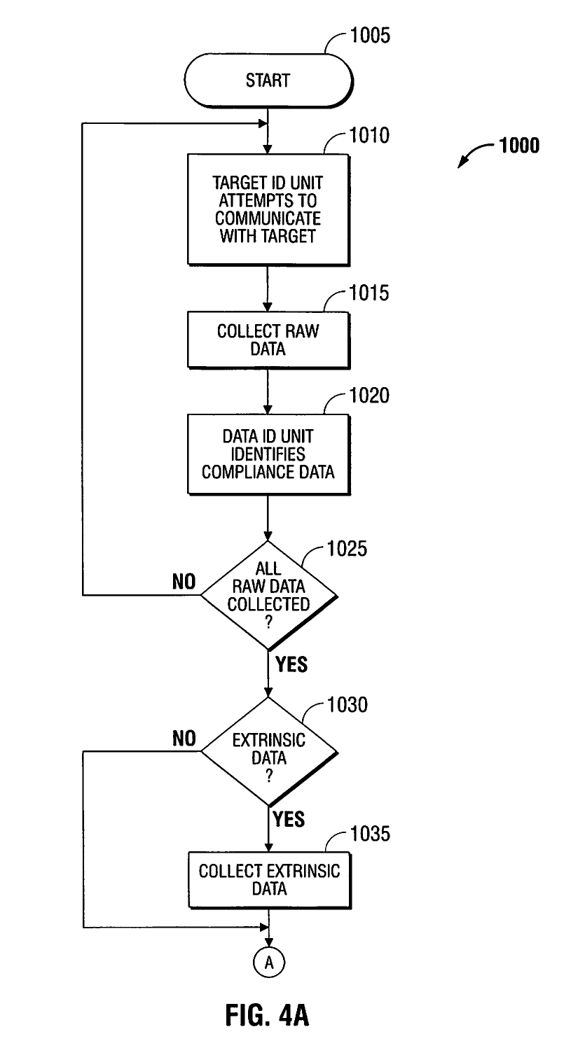

With reference to FIGS. 1, 2, and 3, a GRC system 100 in accordance with the present disclosure includes a regulatory compliance unit 200 that includes at least one processor 210 in operable communication with a data storage unit 220, a data collection unit 400, a compliance scanning unit 500, a reporting unit 600, and a user console unit 700. The regulatory compliance unit 200 includes a communication interface 230 that operably couples the at least one processor 210 and a data network 150. One or more target devices 300 are operably coupled to data network 150. The data collection unit 400 is configured to collect technical data, e.g., “raw data”, from one or more target devices 300, wherein such raw data relates to aspects of an organization that are subject to GRC monitoring.

A target 300 may include, without limitation, a desktop computer, a personal computer, a notebook or laptop computer, a mobile device or “smartphone”, a digital appliance (e.g., networked-attached storage device, a network security device), a network device (e.g., a firewall, a router, a bridge, and the like), and/or any device having the capability to communicate over data network 150. A target 300 may be a physical machine and/or a virtual machine. Data may be collected from a target 300 by the data collection unit 400 by any suitable means, for example and without limitation, by establishing a logical connection to a target (e.g., telnet, ssh, desktop sharing, etc.), by a remote access protocol, a remote procedure call, network traffic interception, intrusive probing, by accessing a resident module 310 installed on a target 300 (e.g., daemons, resident processes, system tray processes, hidden processes), and the like.

In greater detail, a resident module 310 in accordance with the present disclosure may include any software, hardware, or combination software and hardware component that may be included within a target 300. In embodiments, resident module 310 may include the capability to monitor and collect data, including user data, application data, system data, software, combinations thereof, and the like. In embodiments, resident module 310 may include the capability to sense, record, and transmit electrical signals within a target device 300, such as, without limitation, a bus monitoring device that is adapted to operably couple with a target device 300 data bus. In embodiments, resident module 310 may include the ability to sense undesired electromagnetic emissions to facilitate compliance with emission security regulations, such as without limitation, NATO SDIP-27, NATO SDIP-29, AMSG 799B, and USA NSTISSAM regulations.

In another aspect, the disclosed GRC system 100 includes the capability to query an extrinsic resource 330, which may be any entity for which regulatory compliance is required and that cannot be accessed electronically. For example, and without limitation, an extrinsic resource may be a human being within or without the organization, e.g., a corporate officer, an employee, a client, a customer, an independent contractor, and the like. An extrinsic data interface unit 320 enables an extrinsic resource 330 to communicate with regulatory compliance unit 200 and may include, without limitation, any computing device having the capability to run an internet web browser, as described in greater detail below.

For example, and without limitation, data collection unit 400 may be configured to collect the following data:

1. Acquiring network configuration rules, and firewall and router rule sets from mobile devices, desktop computers, clients, servers, firewalls, and routers within the organization via, e.g., Simple Network Management Protocol (SNMP) and/or other suitable protocols.

2. Assessing live assets within the organization through port scanning software.

3. The location of sensitive data within file systems using embedded software.

4. The location of sensitive data within databases using embedded software.

5. The location of sensitive data within domain using embedded software.

6. User access lists from target assets.

7. Application security flaws using application security scanner.

8. Software coding flaws using software code review software.

9. Patch information using patch management software.

10. The status of antivirus, malware, spyware, and the like on various assets using, e.g., antivirus software.

11. Security and other logs from various assets using logging software.

12. Data from third party vulnerability scanners, e.g., Qualys®, Nessus®, Retina Acunetix™, and/or AppScan™, that provide information relating to the security vulnerabilities of assets. Data collected by third-party scanners may be provided to the data collection unit 400 via any suitable means, such as XML, a translation module, a standardized interface, a customized interface, or combinations thereof.

13. Human-provided data (e.g., behavioral data, knowledge data).

14. Sensor-provided data (e.g., occupancy sensors, environmental sensors, process sensors).

Data collection unit 400 includes one or more target identification units 410 that include identifiers and/or parameters relating to predetermined targets within GRC system 100. For example, and without limitation, a target identification unit 410 may identify a target by a network address (e.g., an IPv4 or IPv6 address), a Media Access Control address (MAC address), International Mobile Equipment Identity code (IMEI code), or any suitable electronic identifier adapted to uniquely identify a device and/or a collection of devices (e.g., a network ID). Target identification unit 410 may optionally include authentication information, e.g., username and password, to facilitate access to a target 300. In embodiments, one or more of the identifiers included within target identification unit 410 may be stored in encrypted form.

The data collection unit 400 includes one or more data identification units 415 that are configured to identify and collect data content, e.g., data items, for subsequent compliance evaluation. For example, and without limitation, a data identification unit 415 in accordance with the present disclosure may be configured to recognize and receive credit card account numbers, social security numbers, EIN numbers, bank account and bank routing numbers, telephone numbers, and the like. Data items may be collected in raw form, and optionally, formatted in accordance with a recognized content thereof, for subsequent processing by compliance scanning unit 500. “Raw” data items thus collected may additionally be stored in association with the target resource in which it was located, which, in turn, may facilitate the tracking and remediation of compliance exceptions that may be identified during subsequent compliance scanning.

Data collection unit 400 optionally includes a target discovery unit 430 that is configured to detect one or more targets 300 that have not previously been identified or for which there is limited information. In embodiments, target discovery unit includes the capability to perform a network “crawl” or “spidering” whereby an organization's network is traversed in an orderly fashion to discover, e.g., misconfigured devices having an incorrect or unexpected network address, unauthorized devices that may have been surreptitiously introduced into the network, authorized devices having unauthorized software running thereon (e.g., peer-to-peer file sharing software). In another aspect, target discovery unit 430 may be configured to detect newly-added targets in an organization's network. By automatically identifying new targets in this manner, target discovery unit 430 may reduce administrative requirements and reduce the cost of operating GRC system 100.

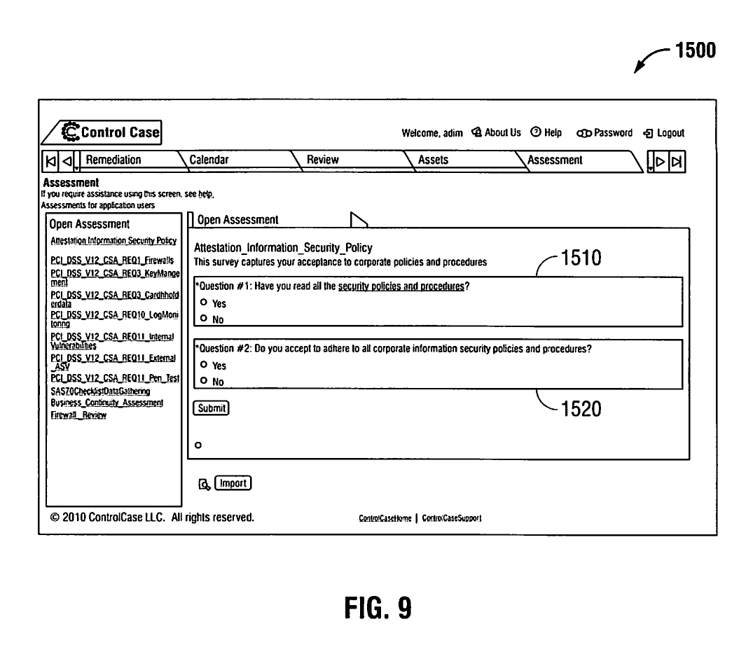

Data collection unit 400 may additionally or alternatively be configured to collect data from an extrinsic target 330, e.g., non-digital assets of an organization, and/or information that cannot readily be acquired via data network 150. In embodiments, data collection unit 400 includes an extrinsic data collection unit 420 that is configured to communicate with extrinsic data interface unit 320 to administer a questionnaire or assessment adapted to collect extrinsic technical data from an extrinsic resource 330. Extrinsic data collection unit 420 includes one or more extrinsic query template(s) 425 that include a set of one or more interrogatories intended to elicit extrinsic data from a user. In embodiments, extrinsic data collection unit 420 includes a webserver (e.g., Apache, Microsoft IIS™, etc.) that is configured to conduct online surveys, questionnaires and/or assessments in which user responses are recorded for subsequent compliance evaluation, as illustrated in FIG. 9. In embodiments, extrinsic data collection unit 420 may be configured to generate printed evaluation input forms, e.g., machine-readable optical forms (e.g., “Scantron™” forms) and/or forms containing one or more machine-readable barcodes, which may be filled out by a user, scanned, and/or user responses thereby recorded for subsequent compliance evaluation. In embodiments, an extrinsic data collection interface may include a barcode scanner or other optical reader adapted to sense information encoded on an evaluation input form.

The compliance scanning unit 500 includes a signature repository 510, a parsing engine 520, and a regulatory mapping unit 530. Signature repository 510 includes one or more compliance signatures 511 that define one or more compliance rules against which collected technical data is evaluated to determine compliance (or non-compliance) therewith. Parser 520 is configured to parse technical data collected by data collection unit 400 in view of the compliance signatures 511.

Parsing engine 520 evaluates collected technical data to determine one or more properties relating to the technical data, e.g., an interpretation of the technical data to ascertain a meaning, context, and/or relevance thereof. The technical data, or a property thereof (e.g., a data length, a checksum, a hash), is compared or mapped to one or more compliance signatures 511 which define a governance, risk, and compliance aspects of data. In addition, metadata relating to the technical data may be stored in association therewith and examined by parsing engine 520. Some non-limiting examples of associated metadata include a timestamp, a source identifier, a hostname, a directory, a filename, a pathname, and/or a database relating to a resource or location where the technical data is stored.

Data that is extrinsic to an organization's data systems (e.g., information not stored on a computer), which may include non-technical data, may be collected through the use of questionnaires or assessments 1500 (FIG. 9) configured to solicit data from an extrinsic resource 330 with knowledge of the extrinsic data. Such questionnaires or assessments 1500 may be administered online by the extrinsic data collection unit 420. In a non-limiting example, a regulatory regime may require certain officers of an organization to read and understand a policy manual. The disclosed scanning unit may solicit information from a user in the form of one or more questions 1510, 1520. The user's response to the questions enables the user's compliance with the regulations (or lack thereof) to be determined. Extrinsic data collected in this manner may be aggregated with other technical data collected electronically for further analysis in accordance with the present disclosure.

In one envisioned embodiment, a compliance signature 511 is embodied in an executable software routine programmed to identify one or more properties relating to the technical data. The compliance signature 511 may include a template for identifying and decoding the technical data. In embodiments, a compliance signature may be expressed by an XML template, a regular expression (e.g., regex or regexp), or other suitable data structure representative of data properties related to the format, use, and expression of the technical data.

Regulatory mapping unit 530 includes one or more regulatory maps 531 that are configured to evaluate parsed technical data in view of predetermined governance, risk, and compliance requirements. By way of a non-limiting example, a regulatory mapping unit 530 may include definitions relating to ISO/IEC 27002 (standards for information security management), SAS 70 (standards for audit reporting), FFIEC (financial institution standards), PCI DSS (standards for credit and debit card security), HIPAA (standards for health-related data privacy), SOX (Sarbanes-Oxley regulations for publicly-held businesses), COBIT (standards for information technology governance), COSO (standards for financial processes and controls), and FISMA and/or NIST 800-53 (security controls for federal information systems). A regulatory map 531 may be added to the regulatory mapping unit 530 by any suitable manner of integration, e.g., plug-in, snap-in, library entry, linking, registry settings, inclusion of one or more definition file(s) to a target directory, DLL, an XML file, and the like.

One or more regulatory maps 531 may be executed during a compliance scan. In this manner, a compliance scan will evaluate the technical data in view of each applicable regulatory regime under which the organization operates. Consider, for example, a healthcare facility such as a hospital. A hospital may accept credit cards as a form of payment for medical services, and thus follows the PCI DSS standards for credit card security. The hospital also maintains patient health records, and thus is required to conform to HIPAA privacy regulations. Accordingly, the regulatory mapping unit 530 will include at least a first regulatory mapping 531 configured to evaluate parsed technical data in view of PCI DSS regulations, and a second regulatory mapping 531 configured to evaluate parsed technical data in view of HIPAAregulations. During a compliance scan, the collected technical data is processed using both the PCI DSS and HIPAA regulatory mappings to assess whether the collected technical data is in compliance with the requirements of both PCI DSS and HIPAA.

More generally, data is evaluated by the compliance scanning unit 500 to determine which parsed data is in compliance with the appropriate standards, and, conversely which data is not in compliance. By way of a non-limiting example, assume that a regulatory mapping 511 dictates that credit card numbers be stored only in encrypted form. During a compliance scan, the compliance scanning unit 500 identifies data which is representative of a credit card number that is stored “in the clear” (i.e., in unencrypted form). During regulatory mapping processing, the unencrypted credit card data, and, additionally or alternatively, the resource in which such data is stored (e.g., the target computing device or an extrinsic resource) will be flagged as non-compliant. The rule(s) that is (are) violated by the non-compliant data may be stored in association with the flagged technical data in, for example, a database, a log file, or other suitable data structure as will be familiar to the skilled artisan.

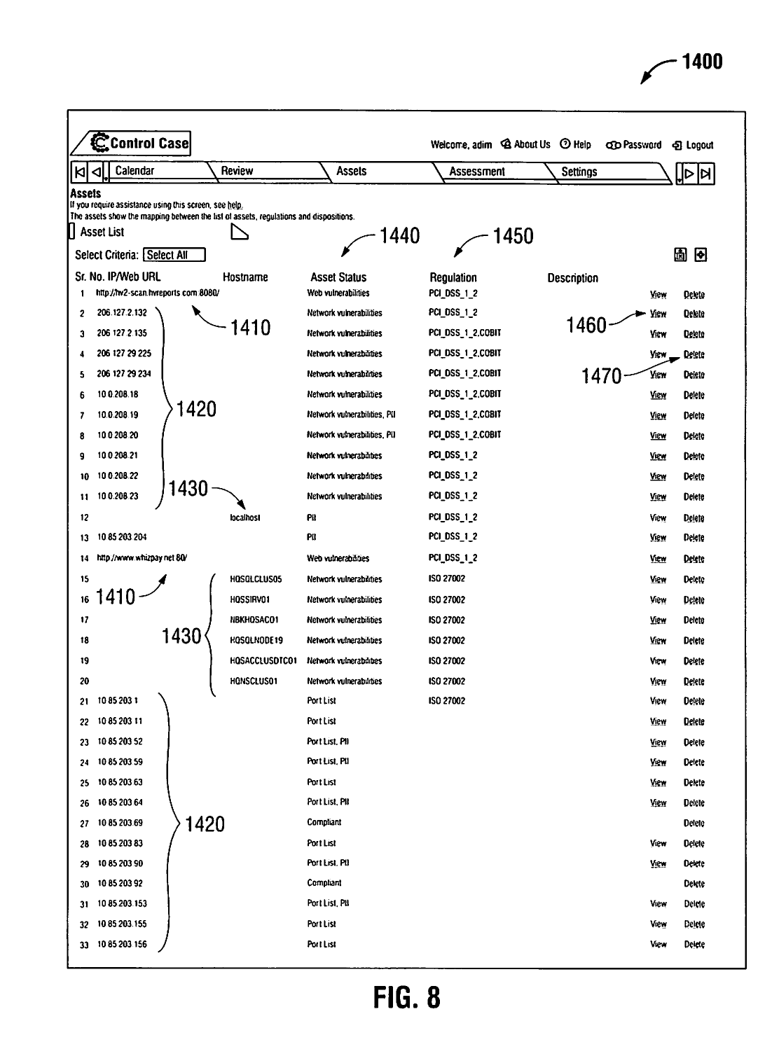

Referring to FIG. 8, assets of the enterprise (e.g., workstations, servers, mobile devices, databases, files, filesystems, etc.) may he discovered and identified, and analyzed for GRC compliance. In an asset view 1400 shown in the example embodiment of FIG. 8, assets are identified by network address, e.g., IP address 1420, web address or URL 1410, hostname 1430, and the like. For a listed asset, the asset status may be displayed. Examples of asset status 1440 include whether the asset is compliant with applicable regulations and policies, or, if non-compliant, a brief and/or detailed description of any regulation and/or policy of which the asset is in violation. Additionally, or alternatively, the precise regulation and/or policy of interest 1450 may be identified. Additional details may be viewed or edited by activating a “view” link 1460 and/or an “edit link (not explicitly shown). The asset entry may be hidden from view, and/or deleted from the asset database, by activating a “delete” link 1470.

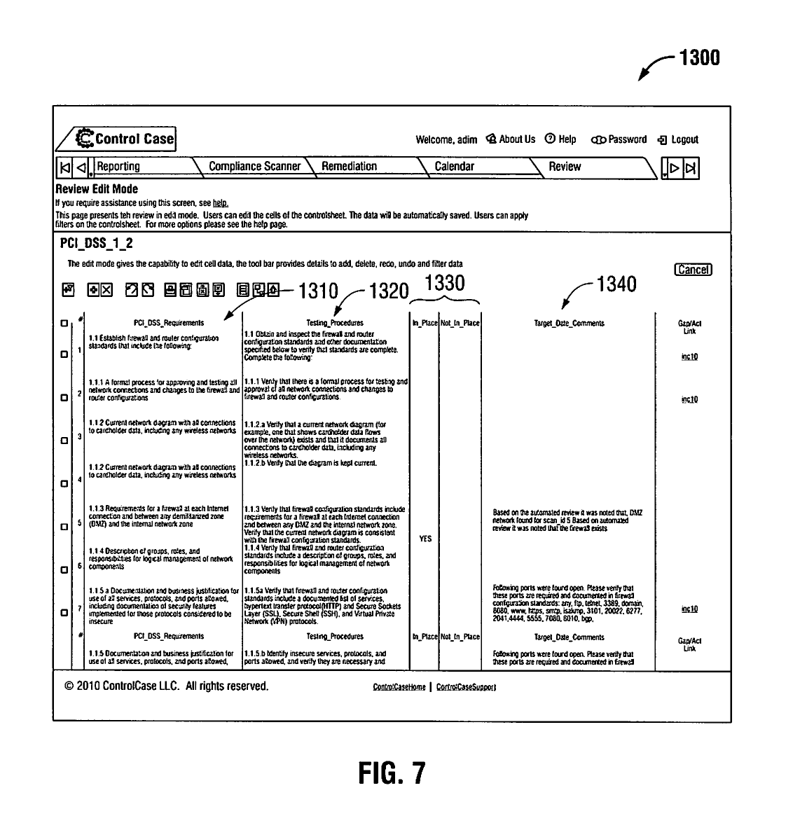

In FIG. 7, another example view 1300 is illustrated that lists specific requirements 1310, and for each listed requirement, one or more testing procedures 1320 that are mapped to the requirement. Additionally, one or more indicators 1330 showing whether the described testing procedure is in place, and comments 1340 relating thereto, may be presented.

Technical data may be collected from sources external to the organizational structure for compliance scanning. Technical data may be collected from trading partners, vendors, merchants, contractors, third party providers, and the like. In this manner, all aspects of an organization (e.g., an entire supply chain) may be evaluated for compliance with applicable standards, policies, and procedures. In embodiments, a network appliance may be configured at a remote site. The network appliance is configured to gather, store, and forward technical data to the compliance scanning unit. The network appliance may include at least a data collection unit, as described herein.

A GRC system and method in accordance with the present disclosure includes a reporting unit 600 configured to format the results of a compliance scan into a presentation view. Additionally or alternatively, in the event a non-compliance is identified, a trouble ticket (a.k.a., an incident) may be opened by the reporting unit 600 and/or the compliance scanning unit 500. In this manner, the organization is able to track and control identified non-compliancies from the initial identification through resolution. The reporting unit 600 may be configured to present scan and analysis results in any of a plurality of formats, including without limitation, pie charts, three-dimensional charts and plots, spreadsheet format, and/or data export formats (e.g., comma-delimited, tab delimited, XML, and the like).

A user console unit 700, or “dashboard” may additionally be provided to enable users and administrators to interact with a GRC system and method in accordance with the present disclosure. Functionality provided by the dashboard may include, but is not limited to, providing the ability to run and/or schedule compliance scans, to define, import, and modify regulatory mappings, to create and edit profiles and/or standards relating to the desired regulatory mapping to be employed, manage user and administrator authentication and access rights, manage assessments (e.g., questionnaires adapted to solicit human input), manage sensor inputs, manage organizational resources and assets (e.g., mobile devices, workstations, and servers within the enterprise that may be scanned), and to schedule and display notifications.

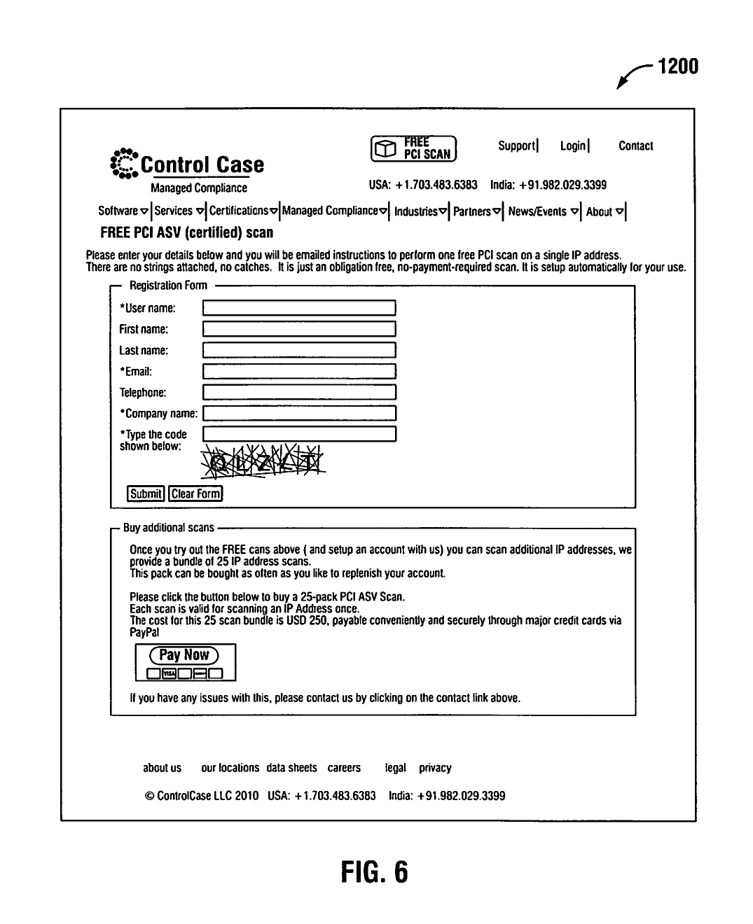

A GRC system in accordance with the present disclosure may be deployed as a web-based or network-based service having the capability to discover and scan one or more assets in an automated manner, thus enabling the use of GRC scanning on an ad hoc basis while requiring little or no administrative effort. In one embodiment illustrated in FIG. 6, a web page 1200 may be provided that enables a user to request a GRC scan to be performed on a specific IP address. The IP address may reside within the public Internet, and/or may reside within a private network or LAN. In embodiments, a publicly-accessible website may enable a user to request a GRC by providing a desired target IP address and associated contact and/or billing information, e.g., an email address to which results may be delivered, a credit card number, account number, or expense code to be charged as payment to the operator of the GRC website for requested scanning services. Additionally or alternative, one or more requirements to be evaluated during the scan may be requested by the user. The GRC system website may be provided within an enterprise intranet, and made available to assets within the intranet.

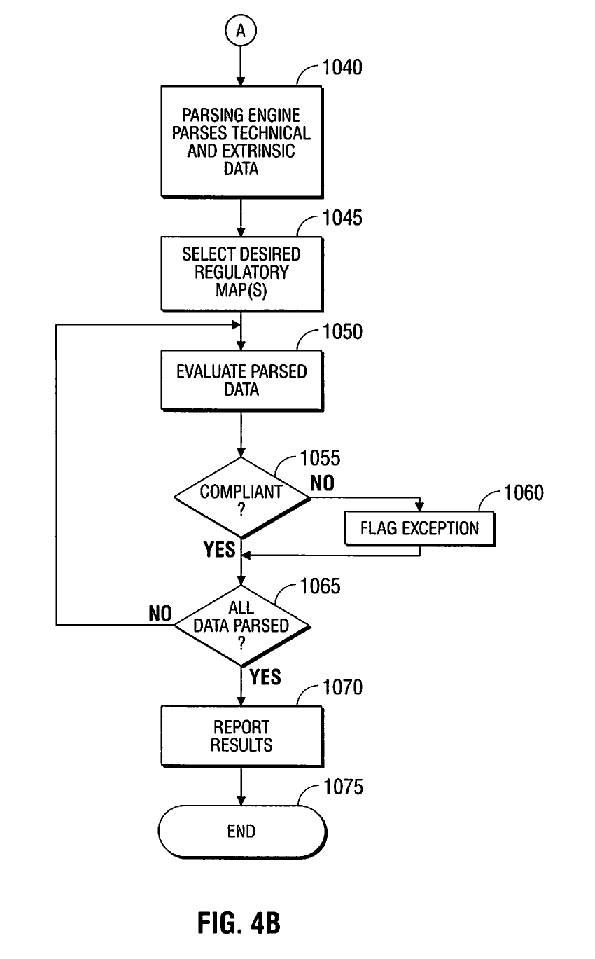

With reference now to FIG. 4A, a GRC scanning method 1000 is disclosed, wherein an initialization step 1005, the GRC system is prepared for use. In embodiments, step 1005 includes specifying one or more targets 300 for scanning and/or technical data to be identified. In the step 1010 the target identification unit 410 attempts to establish communication with a target 300. If contact is successfully established, raw technical data is collected from the target in the step 1015, and in the step 1020, the raw technical data is presented to one or more data identification units 415 to identify an attribute of the raw technical data, and/or to recognize data items that are candidates for compliance analysis (e.g., credit card numbers, social security numbers, software versions, network routing rules, and so forth).

In the step 1025, if additional targets remain to be scanned, the process iterates with the step 1010. The target discovery unit 430 may, in some embodiments, provide the identity of additional targets for scanning. In the step 1030 a determination is made as to whether extrinsic data is to be collected during the compliance scan. In embodiments, this determination may be based, at least in part, upon whether an extrinsic query template 425 exists in association with the present compliance scan. If it is determined that extrinsic data is to be collected, the extrinsic data collection unit 420 attempts to acquire extrinsic data in accordance with one or more extrinsic data templates 425. In embodiments, extrinsic data collection unit 420 will attempt to collect extrinsic data by initiating contact with an extrinsic target 330 via, e.g., email or SMS message and, subsequently, conducting a web-based questionnaire with extrinsic target 330. In some embodiments, extrinsic data collection unit 420 will attempt to contact extrinsic target 330 via telephone using an automated voice response survey to collect the required extrinsic data.

Continuing with reference now to FIG. 4B, the compliance scanning unit 500 analyzes the collected technical and/or extrinsic data. In the step 1040, parsing engine 520 attempts to parse the collected data into lexical units for evaluation. For example, and without limitation, the collected technical data may include a spreadsheet that contains credit card numbers, social security numbers, names, addresses, IP addresses, dates of birth, and the like. Parsing engine 520 is configured to parse the spreadsheet data into discrete lexical units such that each data element is independently identified and segregated for compliance determination.

In the step 1045, the regulatory mapping unit 530 selects the regulatory map(s) 531 against which the parsed data is to be evaluated during the present compliance scan. For example, the organization may wish to comply with PCI DSS and FISMA. The collected data is evaluated with reference to one or more compliance signatures 511 that are specified in the appropriate regulatory map(s) 531. For example, and without limitation, a regulatory map 531 may define or express the requirements for compliance with PCI DSS as a set of one or more compliance signatures 511. In the step 1050, the regulatory mapping unit 530 evaluates the parsed data in view of the set of the compliance signatures 511.

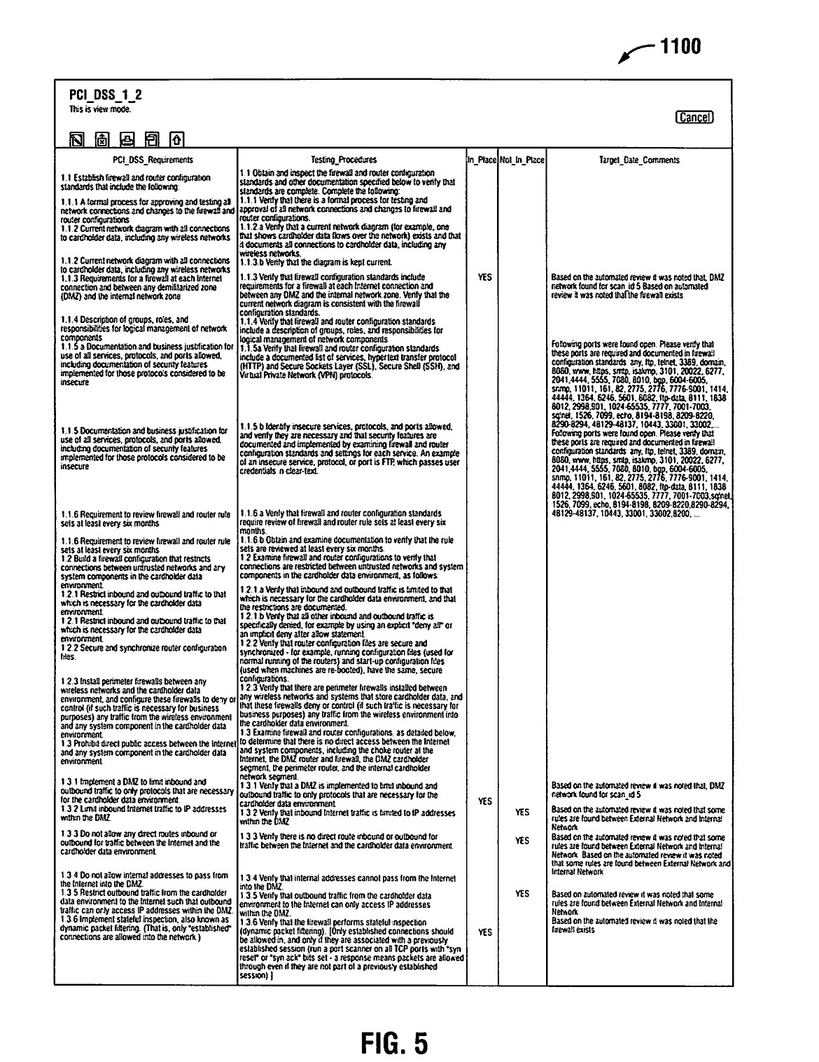

In the step 1055, a determination is made as to whether the parsed data is in compliance with the selected regulatory map(s) 531. If the data is not in compliance, the data is flagged for reporting in the step 1060. In the step 1065, if additional data remains to be evaluated the process iterates with the step 1050. If all parsed data has been evaluated, in the step 1070 the reporting unit 600 presents the results of the compliance scan. For example, the compliance scan results may be presented as a web page 1100 as illustrated in FIG. 5.

While several embodiments of the disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. The claims can encompass embodiments in hardware, software, or a combination thereof. Those skilled in the art will envision other modifications within the scope and spirit of the claims appended hereto.

What is claimed is:

1. A regulatory compliance unit, comprising:
at least one processor;
a data collection unit operably coupled to the processor and comprising:
a target identification unit configured to identify a target for compliance scanning;
a data identification unit configured to:
identify a candidate technical data item in a target; and
receive the identified technical data item;
a compliance scanning unit operably coupled to the processor and comprising:
a signature repository storing one or more compliance signatures defining one or more regulatory compliance rules;
a parsing engine configured to identify regulatory data within identified technical data; and
a regulatory mapping unit configured to evaluate regulatory data in view of one or more regulatory compliance rules;
a reporting unit operably coupled to the processor and configured to present regulatory compliance scan results to a user; and
a user console unit operably coupled to the processor and configured to facilitate user interaction with the regulatory compliance scanning unit.

2. A regulatory compliance unit in accordance with claim 1, wherein the data identification unit is further configured to transmit authentication information to a target.

3. A regulatory compliance unit in accordance with claim 1, wherein the data collection unit further comprises an extrinsic data collection unit configured to receive extrinsic data from an extrinsic data interface unit.

4. A regulatory compliance unit in accordance with claim 3, wherein the extrinsic data interface unit is configured to receive extrinsic data from a user.

5. A regulatory compliance unit in accordance with claim 3, wherein the extrinsic data interface unit is configured to receive extrinsic data information via at least one of a user input or a machine-readable optical code.

6. A regulatory compliance unit in accordance with claim 3, wherein the extrinsic data interface unit includes one or more extrinsic query templates.

7. A regulatory compliance unit in accordance with claim 6, wherein an extrinsic query template defines a questionnaire adapted to solicit human input.

8. A regulatory compliance unit in accordance with claim 1 wherein the user console unit configured to enable a user to configure a parameter related to at least one of the data collection unit, the compliance scanning unit, the reporting unit, a target device, or an extrinsic target.

9. A regulatory compliance unit in accordance with claim 1, wherein the data collection unit further comprises a target discovery unit configured to detect one or more targets not previously identified.

10. A computer-implemented method for performing organizational governance, risk, and compliance management, comprising:
specifying a target for scanning;
establishing a communication link with the specified target;
identifying technical data within the specified target;
receiving the identified technical data;
parsing the technical data into one or more lexical units;
selecting a regulatory map against which the one or more lexical units are evaluated;
determining whether the one or more lexical units is in compliance with the selected regulatory map; and
providing the results of the determining step to a user.

11. The computer-implemented method in accordance with claim 10, further comprising:
determining whether extrinsic data is to be collected;
establishing a communication link with an extrinsic data collection unit;
collecting extrinsic data from an extrinsic data target at the extrinsic data collection unit; and
receiving the collected extrinsic data.

12. The computer-implemented method in accordance with claim 11, further comprising:
contacting an extrinsic data target by an email message, an SMS message, or by a telephone call.

13. The computer-implemented method in accordance with claim 10, further comprising providing a remediation suggestion to a user in response to a determination that the one or more lexical units is not in compliance with the selected regulatory map.

14. The computer-implemented method in accordance with claim 10, wherein the results of the determining step are provided to a user by a web browser.

15. The computer-implemented method in accordance with claim 10, wherein the specifying step includes specifying an IP address of the target device.

16. The computer-implemented method in accordance with claim 10, further comprising receiving payment information from a user.

17. Non-transitory machine-readable media storing a set of instructions executable on a processor for performing a method for performing organizational governance, risk, and compliance management, the method comprising:
specifying a target for scanning;
establishing a communication link with the specified target;
identifying technical data within the specified target;
receiving the identified technical data;
parsing the technical data into one or more lexical units;
selecting a regulatory map against which the one or more lexical units are evaluated;
determining whether the one or more lexical units is in compliance with the selected regulatory map; and
providing the results of the determining step to a user.

18. The non-transitory machine-readable media in accordance with claim 17, wherein the method further comprises:
determining whether extrinsic data is to be collected;
establishing a communication link with an extrinsic data collection unit;
collecting extrinsic data from an extrinsic data target at the extrinsic data collection unit; and
receiving the collected extrinsic data.

19. The non-transitory machine-readable media in accordance with claim 17, wherein the method further comprises providing a remediation suggestion to a user in response to a determination that the one or more lexical units is not in compliance with the selected regulatory map.

20. The non-transitory machine-readable media in accordance with claim 17, wherein the method further comprises transmitting authentication information to a target device.
